(19) United States
(12) Patent Application Publication
(10) Pub. No.: US 2010/0001679 A1
(43) Pub. Date: Jan. 7, 2010

(54) ACCELERATION CONTROL APPARATUS AND METHOD

(75) Inventors: RONG-HWANG HORNG, Tu-Cheng (TW); WEI-DER TANG, Tu-Cheng (TW); YAW-SHEN LAI, Tu-Cheng (TW); JHY-HAU CHIU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/346,887

(22) Filed: Dec. 31, 2008

(30) Foreign Application Priority Data
Jul. 4, 2008 (CN) 200810302548.6

(51) Int. Cl. G05B 19/404

(52) U.S. Cl. 318/601

(57) ABSTRACT

An acceleration control apparatus for servo control of a computer numerical control (CNC) machine comprises a digital filter. The digital filter is obtained by selecting a cutoff frequency of an analog filter and using a pole-zero matched method to transform an analog filter. The low-pass digital filter includes a signal input unit, a signal input register unit, a signal operation unit, a signal output unit, and a signal output register unit.

### BACKGROUND

1. Field of the Invention

The disclosure relates to servo controls and, specifically, to an acceleration servo control apparatus for numerical control (NC) machine tools, industrial robots, and others.

2. Description of Related Art

Servo motors are widely used in computer numerical control (CNC) machines, generally being controlled for required operations by a servo circuit for each axle, responding to external operational commands applied through an interpolation circuit. In these CNC machines, the servo motors are liable to produce vibration when the value of the external operational command changes considerably, for example, when the servo motors are started or stopped. Conventionally, therefore, vibration is restrained by an acceleration control system of the servo motor. The operational command from the interpolator is delivered through a linear acceleration control system and executes an acceleration system operation to obtain a modified operational command for the servo circuit. As shown in FIG. 7, part (A), a waveform shows the acceleration speeds modified by a linear acceleration control system; however, when the acceleration speed abruptly changes, a jolt is induced, subjecting the servo motor to shock resulting in vibration. Therefore, it is necessary to develop an appropriate acceleration control system for accurate and smooth operation of CNC machines. Accordingly, several kinds of acceleration control systems, such as exponent curve and bell curve acceleration control systems, as shown in FIGS. 7, parts (B) and (C), can replace the linear acceleration control system to obtain smooth motion control.

Another acceleration control system, provided by a post-acceleration control unit, utilizes three-move-averaging to contain the vibration and obtain a smoother motion control.

FIGS. 8 and 9 show the acceleration control unit 20 including first, second and third filters 21, 22 and 23, each filter comprising a set of registers, Z₁⁻, Z₂⁻¹, Z₃⁻¹ . . . Zₙ₋₁⁻¹, an adder 211, and a multiplier 212. The first filter 21, second filter 22 and third filter 23 output signals C2, C3 and C4 to the corresponding second filter 22, third filter 23, and driving unit 24, respectively. The first filter 21 receives the velocity signal C1 from an interpolation circuit in the CNC machine and outputs a velocity signal C2 to the second filter 22; the second filter 22 receives the velocity signal C2 and outputs the velocity signal C3 to the third filter 23; and the third filter 23 receives the velocity signal C3 and outputs the signal C4 to the driving unit 24. The three-move-averaging levels the velocity curve and contains vibration, however, this method provides only one parameter to set the acceleration time.

What is needed, therefore, is an acceleration control apparatus and method addressing the limitations described.

### BRIEF DESCRIPTION OF THE DRAWINGS

FIG. 1 shows an acceleration control apparatus according to an embodiment.

FIG. 2 is a block diagram of a signal operation unit, a signal input register unit, and a signal output register unit of the acceleration control apparatus shown in FIG 1.

FIG. 3 is a flowchart of a method for the acceleration control apparatus shown in FIG. 1, according to an embodiment.

FIG. 4 is a graph of velocity pulse received by the signal input register unit of the acceleration control apparatus shown in FIG. 1.

FIG. 5 is a graph of the acceleration pulse, wherein cutoff frequency is 1 kHz, output by the signal operation unit of the acceleration control apparatus shown in FIG. 1.

FIG. 6 is similar to FIG. 5, with cutoff frequency of 300 Hz.

FIG. 7, part (A) is a graph of a related-art linear acceleration control system.

FIG. 7, part (B) is a graph of an related-art exponent curve acceleration control system.

FIG. 7, part (C) is a graph of a related-art bell curve acceleration control system.

FIG. 8 is a schematic block diagram showing a commonly used, related-art acceleration control apparatus.

FIG. 9 is a block diagram of a filter of the acceleration control apparatus shown in FIG. 8.

### DETAILED DESCRIPTION

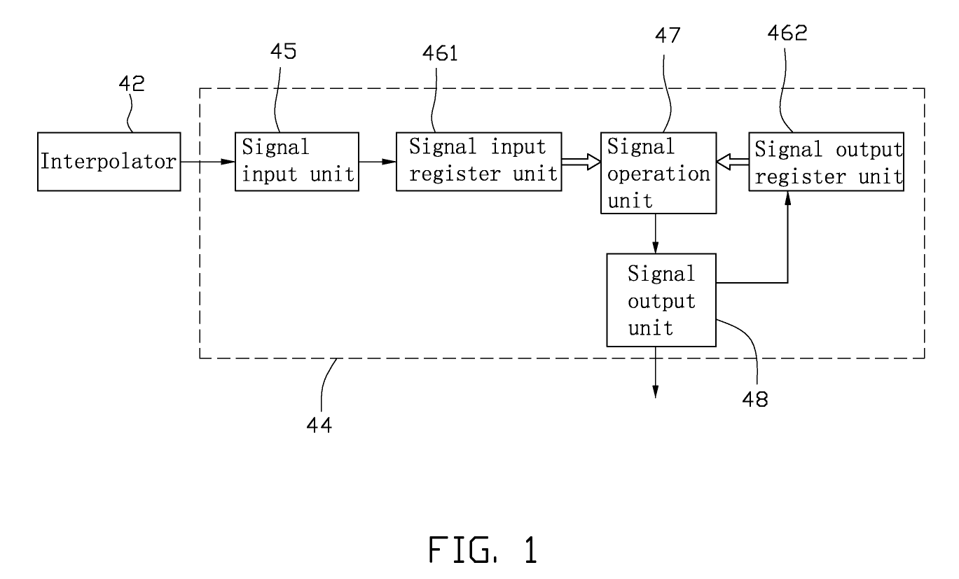

FIG. 1 shows an acceleration control apparatus according to the disclosure, here being a low-pass digital filter 44 obtained by transformation of a third-order Butterworth analog filter. A cutoff frequency of the third-order Butterworth analog filter is selected, after which the analog filter is transformed into the digital filter by a pole-zero matched method. The low-pass digital filter 44 includes a signal input unit 45, a signal input register unit 461, a signal operation unit 47, and a signal output unit 48, arranged in series, and a signal output register unit 462 electrically connected to the signal operation unit 47 and the signal output unit 48.

A velocity signal pulse from the interpolator 42 is stored into the signal input register unit 461 via the signal input unit 45. The signal operation unit 47 processes an addition and a multiplication operation for the velocity signal pulse, and outputs the resultant value to the servo circuit via signal output unit 48 to drive the servo motor. Furthermore, the resultant value is conveyed to the signal output register unit 462 and stored therein for following operation.

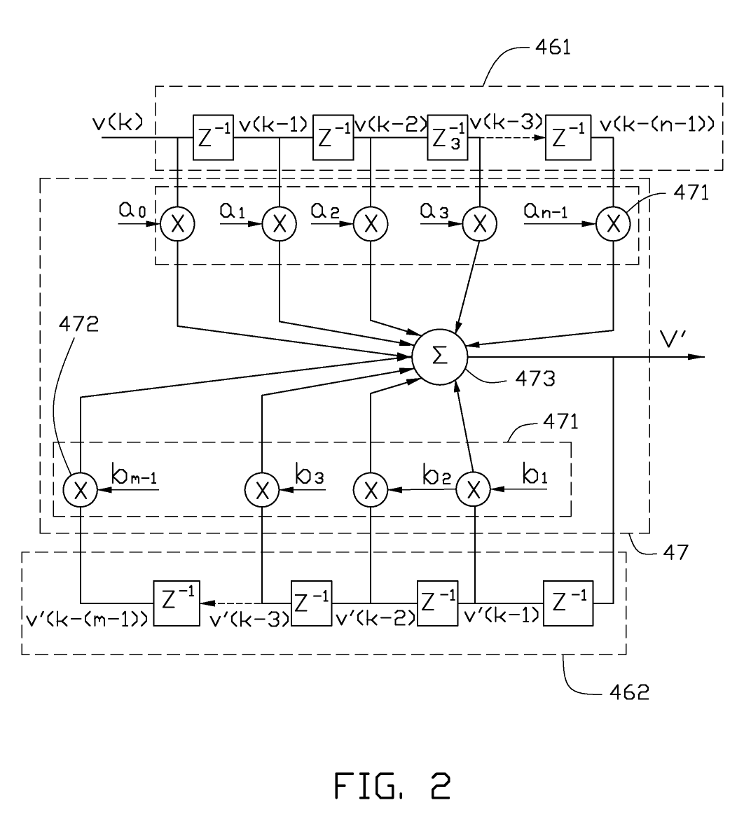

As shown in FIG. 2, the operation unit 47 includes n input multipliers 471, m output multipliers 472, and an adder 473. The signal register unit 461 includes n−1 delay units Z⁻¹ which correspond to the n−1 input multipliers 471 having weights a₁, a₂ . . . aₙ₋₁. The first n−1 velocity signal pulses V(k−1), V(k−2), V(k−3) . . . V(k−(n−1)) from the interpolator 42 are stored in the n−1 delay units Z The first n−1 velocity signal pulses V(k−1), V(k−2), V(k−3) . . . V(k−(n−1)) and the n th velocity signal pulses V(k) are multiplied by the corresponding weights a₁, a₂ . . . aₙ₋₁ and a₀ respectively. These resultant values are added by an adder 473. In addition, a feedback value from output multipliers 472 is added into the resultant to obtain an output velocity signal pulse V′(k). The output velocity signal pulses V′(k) via the signal output unit 48 drive the servo motor; moreover, the output velocity signal pulses V′(k) are conveyed to the signal output register unit 462 and stored therein. The signal output register unit 462 includes m−1 delay units Z⁻¹ which correspond to the m−1 output multipliers 472 having weights b1, b2, b3 . . . bm−1. The first m−1 velocity signal pulses V′(k−1), V′(k−2), V′(k−3) . . . V′(k−(m−1)) from the signal output unit 48 are stored in the m−1 delay units Z⁻¹. The first m−1 velocity signal pulses V′(k−1), V′(k−2), V′(k−3) . . . V′(k−(m−1)) are multiplied by the corresponding output multipliers 471 having the weights b1, b2, b3 . . . bm−1. The resultant values are added by an adder 473. The numbers of output multipliers 471 do not equal the numbers of the output multipliers 472; namely, n is not equal to m. The two sets of weights a0, a1, a2 . . . an−1, b1, b2, b3 . . . bm−1, and the output velocity signal pulses V′(k−1), V′(k−2), V′(k−3) . . . V′(k−(m−1)) are obtained by the pole-zero Matched method.

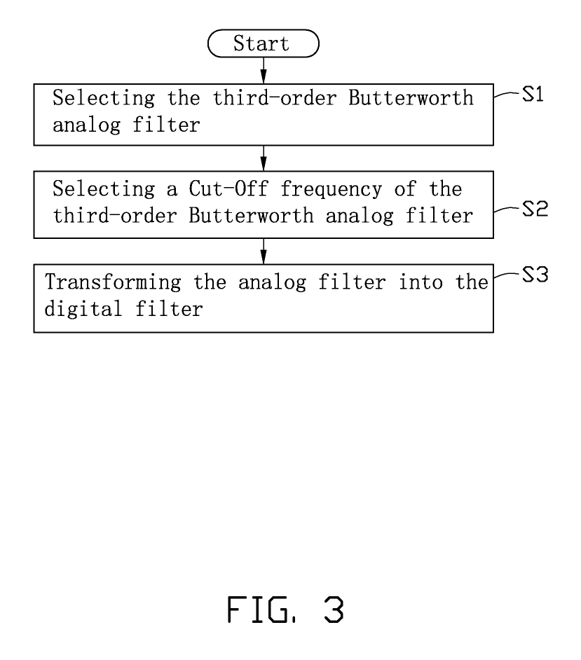

As shown in FIG. 3, according to the disclosure, a method for obtaining a low-pass digital filter replaces a moving average method. The method comprises: (1) selecting the third-order Butterworth analog filter, (2) selecting a cutoff frequency of the third-order Butterworth analog filter, and (3) transforming the analog filter into the digital filter.

In step (1) the Butterworth analog filter is linearized. Gain is set at 1 and cutoff frequency is 1 rad/s. The Butterworth filter is designed to provide frequency response as flat as mathematically possible in the high-pass and low-pass. The linearized Butterworth analog filter can be expressed as:

$$G ( s ) = {\prod }_{j = 1}^{n} \frac{1}{s + {b}_{j}} = \frac{1}{{B}_{n} ( s )}$$

$${b}_{j} = exp [ - iπ ( \frac{1}{2} + \frac{2 j - 1}{2 n} ) ] , \qquad i = \sqrt{- 1}$$

where Bₙ(s) is:

$${B}_{n} ( s ) = {\prod }_{k = 1}^{\frac{n}{2}} [ {s}^{2} - 2 s cos ( \frac{2 k + n - 1}{2 n} π ) + 1 ]$$

for n is even;

$${B}_{n} ( s ) = ( s + 1 ) {\prod }_{k = 1}^{\frac{n - 1}{2}} [ {s}^{2} - 2 s cos ( \frac{2 k + n - 1}{2 n} π ) + 1 ]$$

for n is odd;
Bₙ(s) is represented by four decimal places, according to different order of the Butterworth analog filter are:

| n | Bₙ(s) |
|---|---|
| 1 | (s + 1) |
| 2 | s² + 1.4142s + 1 |
| 3 | (s + 1)(s² + s + 1) |
| 4 | (s² + 0.7654s + 1)(s² + 1.8478s + 1) |
| 5 | (s + 1)(s² + 0.6180s + 1)(s² + 1.6180s + 1) |
| 6 | (s² + 0.5176s + 1)(s² + 1.4142s + 1)(s² + 1.9319s + 1) |
| 7 | (s + 1)(s² + 0.4450s + 1)(s² + 1.2470s + 1)(s² + 1.8019s + 1) |

n is the order of Butterworth analog filter.

Utilizing third-order Butterworth filter, the linearized Butterworth filter is:

$$G ( s ) = \frac{1}{{s}^{3} + 2 {s}^{2} + 2 s + 1}$$

The velocity signal pulse via the interpolator 42 is step instruction. Step instruction via the three times differential operation of the third-order Butterworth analog filter obtains a jolt instruction. The jolt is a continuous function.

In Step (2), cutoff frequency of the third-order Butterworth analog filter is selected according to the control bandwidth of the control system. Generally, the control bandwidth of a control system is about 200 Hz-500 Hz. Here, cutoff frequency is twice the system control bandwidth, and 1 kHz is selected accordingly. After deciding the cutoff frequency of the Butterworth analog filter, a low pass filter is obtained as:

$$G ( s ) = \frac{3.1006 * {10}^{10}}{{s}^{3} + ( 6.1832 * {10}^{3} ) {s}^{2} + ( 1.9730 * {10}^{7} ) s + 3.1006 * {10}^{10}}$$

Step (3) transforms the low pass filter G(s) into a digital filter G(z) by the pole-zero matched method. The low-pass filter G(s) obtained by step (2) is a continuous function. Utilizing the Cutoff frequency is 1 kHz, the digital filter G(z) is:

$$G ( z ) = \frac{0.3403 {z}^{2} + 0.6806 z + 0.3403}{\begin{matrix}{z}^{3} + ( 3.3626 * {10}^{- 1} ) {z}^{2} + \\ ( 2.6815 * {10}^{- 2} ) z - ( 1.8674 * {10}^{- 3} )\end{matrix}}$$

Reorganization of the formula provides:

$$\begin{matrix}G ( z ) = \frac{{V}^{′} ( z )}{V ( z )} \\ = \frac{0.3403 {z}^{- 1} + 0.6806 {z}^{- 2} + 0.3403 {z}^{- 3}}{\begin{matrix}1 + ( 3.3626 * {10}^{- 1} ) {z}^{- 1} + \\ ( 2.6815 * {10}^{- 2} ) {z}^{- 2} - ( 1.8674 * {10}^{- 3} ) {z}^{- 3}\end{matrix}} \\ = \frac{{a}_{0} + {a}_{1} {z}^{- 1} + {a}_{2} {z}^{- 2} + {a}_{3} {z}^{- 3}}{1 + {b}_{1} {z}^{- 1} + {b}_{2} {z}^{- 2} + {b}_{3} {z}^{- 3}}\end{matrix}$$

where z⁻¹ is a delay unit, V(k) is the velocity signal pulse at k th sampling time under a continual series in a time domain, wherein V(k−1)=V(k)z⁻¹, V(k−1) is a velocity signal pulse expressing passage of the velocity signal pulses V(k) through a delay unit. The velocity signal pulse V(k) passes through p delay units, V(k−p)=V(k)z^{-p}. The digital filter G(z) can be changed to another formula, in which input and output signals of the digital filter G(z) are used in place of the serial function after sampling, resulting in:

V′(k)=a₀V(k)+a₁V(k−1)+a₂V(k−2)+a₃V(k−3)−b₁V′(k−1)−b₂V′(k−2)−b₃V′(k−3)

wherein k>0, V(−1)=V(−2)=V(−3)=V′(−1)=V′(−2)=V′(−3)=0

Here, the input multiplier factor a0, a1, a2 . . . an−1 and the output multiplier factor b1, b2, b3 . . . bm−1 of the third-order Butterworth analog filter continuous system are special integers, and n and m are 4; thus the input multipliers are a0, a1, a2, a3 and the output multipliers b1, b2, b3, which substitute for digital filter 44.

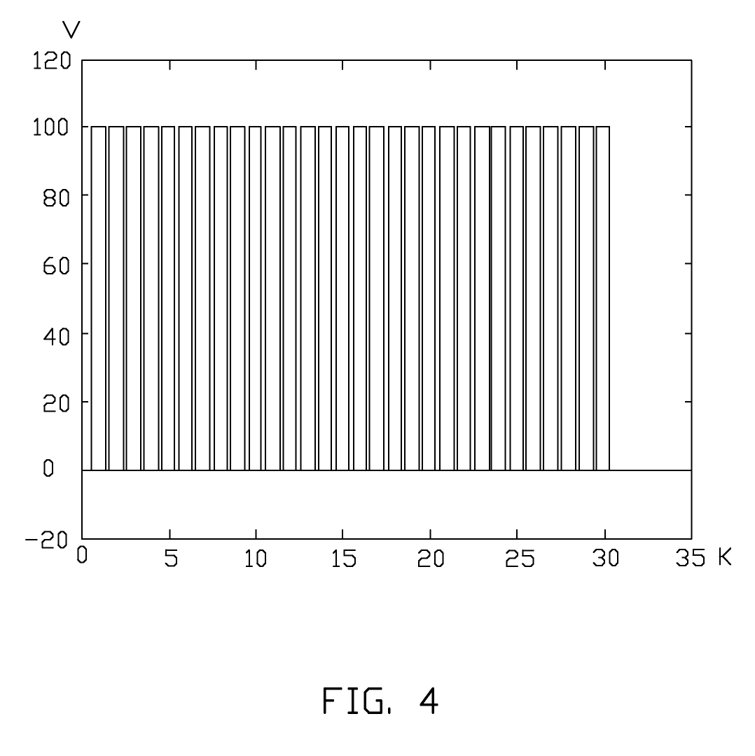

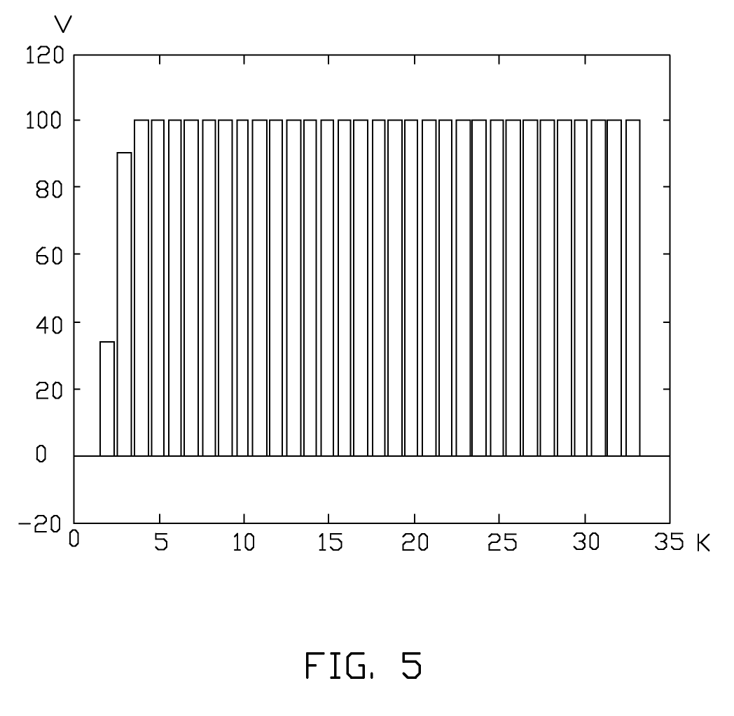

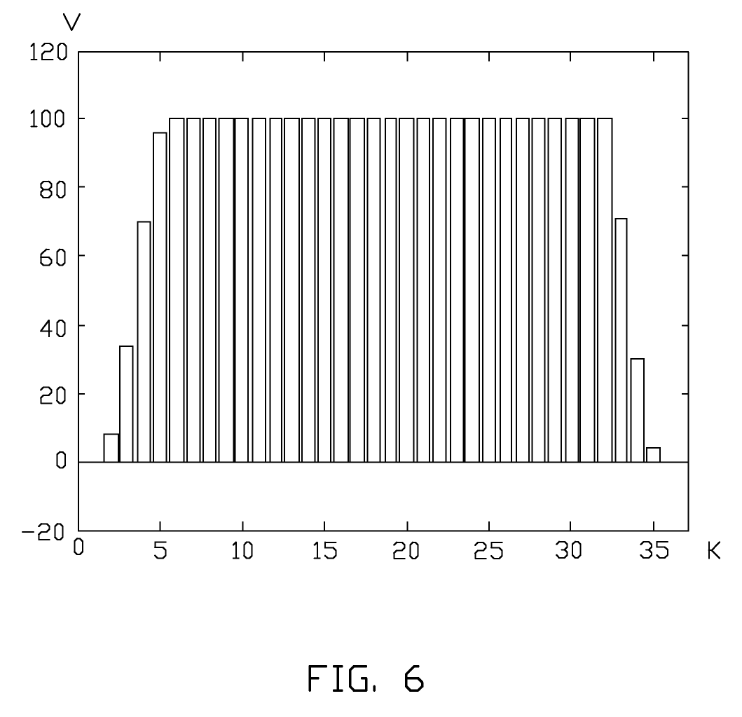

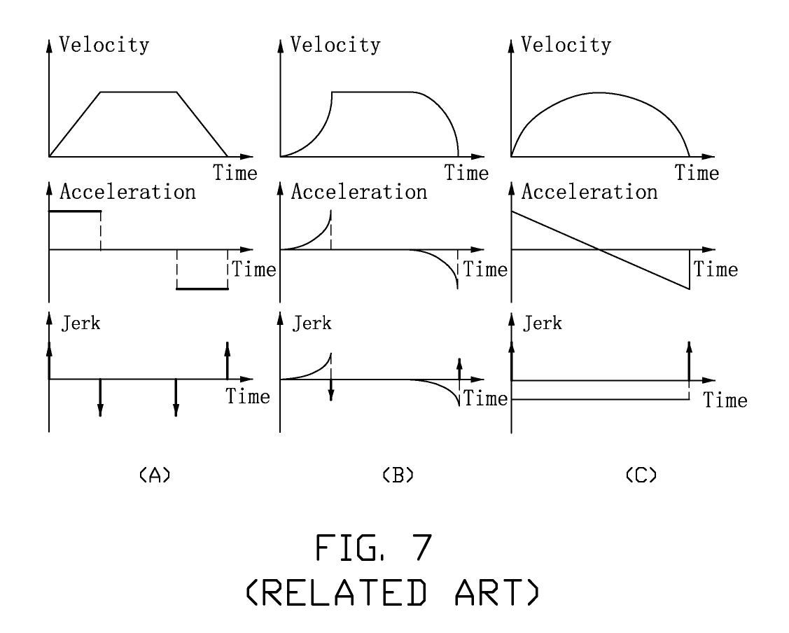

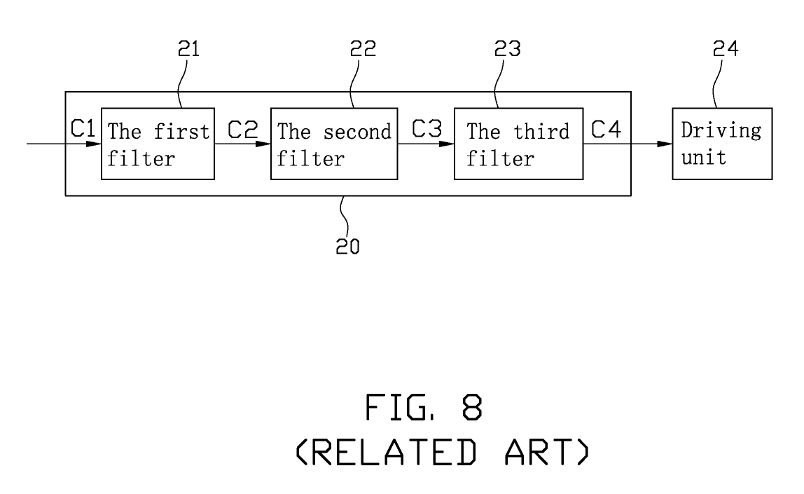

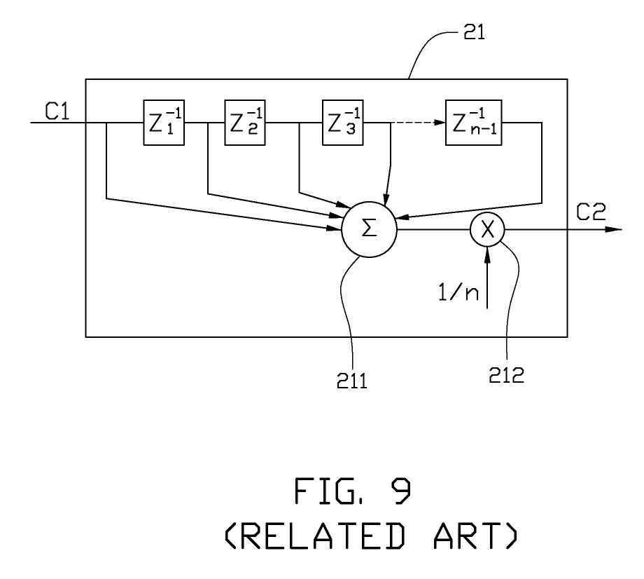

The preceding 30 times input velocity signal pulses from the interpolator 42, as shown in FIG. 4, are 100 pps. Because the actual output signal pulse cannot be less than one step, the fraction, after Butterworth analog filter operation, is accumulated for output at the next sampling. The velocity signal pulses calculated by Butterworth analog filter are shown in Table 1.

TABLE 1

| | Original velocity single | velocity single pulse after |
|---|---|---|
| Num. | pulse | filter |
| 1 | 100 | 0 |
| 2 | 100 | 34 |
| 3 | 100 | 90 |
| 4 | 100 | 100 |
| 5 | 100 | 100 |
| 6 | 100 | 100 |
| 7 | 100 | 100 |
| 8 | 100 | 100 |
| 9 | 100 | 100 |
| 10 | 100 | 100 |
| 11 | 100 | 100 |
| 12 | 100 | 100 |
| 13 | 100 | 100 |
| 14 | 100 | 100 |
| 15 | 100 | 100 |
| 16 | 100 | 100 |
| 17 | 100 | 100 |
| 18 | 100 | 100 |
| 19 | 100 | 100 |
| 20 | 100 | 100 |
| 21 | 100 | 100 |
| 22 | 100 | 100 |
| 23 | 100 | 100 |
| 24 | 100 | 100 |
| 25 | 100 | 100 |
| 26 | 100 | 100 |
| 27 | 100 | 100 |
| 28 | 100 | 100 |
| 29 | 100 | 100 |
| 30 | 100 | 100 |
| 31 | 0 | 100 |
| 32 | 0 | 70 |
| 33 | 0 | 9 |
| 34 | 0 | 0 |
| 35 | 0 | 0 |

According to the altered cutoff frequency, for example, of 300 Hz, the velocity signal pulses calculated by Butterworth analog filter are shown in Table 2.

TABLE 2

| | Original velocity single | Velocity single pulse after |
|---|---|---|
| Num. | pulse | filter |
| 1 | 100 | 0 |
| 2 | 100 | 8 |
| 3 | 100 | 34 |
| 4 | 100 | 70 |
| 5 | 100 | 96 |
| 6 | 100 | 100 |
| 7 | 100 | 100 |
| 8 | 100 | 100 |
| 9 | 100 | 100 |
| 10 | 100 | 100 |
| 11 | 100 | 100 |
| 12 | 100 | 100 |
| 13 | 100 | 100 |
| 14 | 100 | 100 |
| 15 | 100 | 100 |
| 16 | 100 | 100 |
| 17 | 100 | 100 |
| 18 | 100 | 100 |
| 19 | 100 | 100 |
| 20 | 100 | 100 |
| 21 | 100 | 100 |
| 22 | 100 | 100 |
| 23 | 100 | 100 |
| 24 | 100 | 100 |
| 25 | 100 | 100 |
| 26 | 100 | 100 |
| 27 | 100 | 100 |
| 28 | 100 | 100 |
| 29 | 100 | 100 |
| 30 | 100 | 100 |
| 31 | 0 | 100 |
| 32 | 0 | 100 |
| 33 | 0 | 71 |
| 34 | 0 | 30 |
| 35 | 0 | 4 |
| 36 | 0 | 0 |
| 37 | 0 | 0 |
| 38 | 0 | 0 |

While the invention has been described by way of example and in terms of preferred embodiment, it is to be understood that the invention is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An acceleration control apparatus for servo control of a computer numerical control (CNC) machine, comprising a digital filter obtained by selecting a cutoff frequency of an analog filter and using a pole-zero matching method to transform the analog filter, the digital filter comprising a signal input unit, a signal input register unit, a signal operation unit, a signal output unit, and a signal output register unit, wherein the signal input unit is configured to receive a velocity signal pulse;
the signal input register unit is connected to the signal input unit and configured to store the velocity signal pulse; the signal input register comprises a plurality of delay units arranged in series;
the signal operation unit, connected to the signal input register unit, the signal output unit, and the signal output register unit, is configured to receive the velocity signal pulse and output an acceleration pulse signal,
the signal output unit is connected to the signal operation unit and configured to transform the acceleration pulse signal to a driving signal;
a signal output register unit connected to the signal output unit and a signal operation unit, configured to receive and store the acceleration pulse signal, and the signal input register unit further comprises a plurality of delay units arranged in series;
the signal operation unit further comprises an input multiplier, an output multiplier, and an adder, wherein
the input multiplier is capable of multiplying a plurality of weight values corresponding to the delay units of the signal input register unit by the velocity signal pulse values stored in the delay units;
the output multiplier is capable of multiplying a plurality of weight values corresponding to a plurality of delay units of the signal output register unit by the acceleration pulse signal values stored in the delay units; and
an adder connected to the input and output multipliers and configured to sum the velocity signal pulse values and the acceleration pulse signal values;

2. The acceleration control apparatus as claimed in claim 1, wherein the analog filter is a Butterworth analog filter, and the digital filter is a low-pass filter.

3. An acceleration control method for servo control of a computer numerical control (CNC) machine, comprising:
providing an analog filter;
selecting a cutoff frequency of the analog filter;
transforming the analog filter into a digital filter comprising a signal input unit, a signal input register unit, a signal operation unit, a signal output unit, and a signal output register unit;
receiving a velocity signal pulse by the signal input unit from an interpolator;
storing the velocity signal pulse in the signal input register unit;
calculating an acceleration pulse signal by the signal operation unit based on the received velocity signal pulse, being connected to the signal input register unit;
receiving the acceleration pulse signal and obtaining a driving signal transformed by the signal output unit, based on the acceleration pulse signal, to drive a motor, the signal output unit being connected to the signal operation unit; and
storing the acceleration pulse signal in the signal output register unit for calculation in the signal operation unit; the signal output register unit being connected to the signal operation unit and the signal output unit.

4. The acceleration control method as claimed in claim 3, wherein the analog filter is a third-order Butterworth analog filter, and the cutoff frequency is 1 kHz.

5. The acceleration control method as claimed in claim 3, wherein the digital filter is transformed by a pole-zero matched method, and the digital filter is a low-pass digital filter.

6. The acceleration control method as claimed in claim 3, wherein the signal input register unit comprises a plurality of delay units connected to the signal input unit.

7. The acceleration control method as claimed in claim 6, wherein the signal output register unit comprises a plurality of delay units connected to the signal output unit and signal operation unit.

8 The acceleration control method as claimed in claim 7 wherein the signal operation unit further comprises an input multiplier, an output multiplier, and an adder, wherein
the input multiplier multiplies a plurality of weight values corresponding to the delay units of the signal input register unit by the velocity signal pulse values stored in the delay units;
the output multiplier multiplying a plurality of weight values corresponding to a plurality of delay units of the signal output register unit by the acceleration pulse signal values stored in the delay units; and
an adder connected to the input and output multipliers summing the velocity signal pulse values and the acceleration pulse signal values.
